(19) United States
(12) Patent Application Publication
(10) Pub. No.: US 2024/0158012 A1
(43) Pub. Date: May 16, 2024

(54) Motor Vehicle Body for an Electrically Drivable Motor Vehicle

(71) Applicant: Bayerische Motoren Werke Aktiengesellschaft, Muenchen (DE)

(72) Inventors: Josip DURMIS, Poing (DE); Lorenz KRIEGLER, Rottenegg (DE); Sebastian ZECH, Olching (DE)

(21) Appl. No.: 18/284,567

(22) PCT Filed: Apr. 8, 2022
(86) PCT No.: PCT/EP2022/059405

§ 371 Date: Sep. 28, 2023

(30) Foreign Application Priority Data
Apr. 30, 2021 (DE) 10 2021 111 248.6

(51) Int. Cl. B62D 21/15; B60K 1/04; B60L 50/60; B62D 25/20

(52) U.S. Cl. CPC B62D 21/152; B60K 1/04; B60L 50/66; B62D 25/2018; B60K 2001/0438

(57) ABSTRACT

A motor vehicle body for an electrically drivable motor vehicle includes: a vehicle floor element, which transitions, at the front end of a passenger compartment, into a firewall; longitudinal members of a front-end structure, the rear ends of the longitudinal members being fastened to the firewall and, at a point of connection, to the vehicle floor element; and a stored energy source, which is located below the vehicle floor element and a front end of which is located below the rear ends of the longitudinal members. In order to provide a motor vehicle body with favorable characteristics in a frontal collision with an obstacle or a vehicle, the vehicle floor element has, behind the points of connection to the rear ends of the longitudinal members, respective embossed portions formed upward in the vehicle vertical direction, and/or the points of connection of the rear ends of the longitudinal members to the vehicle floor element have deliberately weakened portions.

### BACKGROUND AND SUMMARY

The invention relates to a motor vehicle body.

Particularly when motor vehicle bodies are used for different drive concepts for vehicles, exclusively with an internal combustion engine (ICE), with a hybrid drive (PHEV), or with a purely electric drive (BEV), the problem that arises with electrically drivable models is that the electrical energy store has to be accommodated below the vehicle floor. The respective longitudinal members of a front-end structure, which are also occasionally referred to as engine mounts, therefore have to be largely dispensed with in the underfloor area of the energy store below the vehicle floor. Typically, short stubs of longitudinal members remain immediately in front of the energy store below the vehicle floor and end in close proximity above the front end of the energy store.

During a frontal collision in this case with low width overlap between the colliding vehicles, if, for example, one of these longitudinal members were to be subjected to an accident-related force, they may no longer be able to transfer appropriate forces rearward due to the applied moments, particularly about the vehicle transverse axis, which can cause the longitudinal members to rotate upwards with their front end or downwards with their rear end. This rotational movement at the rear end of the respective longitudinal member can cause the connection point in each case, at which the corresponding stub of the longitudinal member is rearwardly connected to the vehicle floor element, to cause the vehicle floor element in the region of this connection point to be pulled downwards or deformed due to the rotation of the longitudinal member. In extreme cases, this can result in the rear portion of the longitudinal member and of the vehicle floor element being pressed against the storage housing of the energy store or causing an implosion into the storage housing of the energy store which, in the worst case scenario, can cause damage to the storage cells of the energy store.

The object of the present invention is therefore to provide a motor vehicle body for an electrically drivable motor vehicle, in which damage to the energy store, particularly in the event of a frontal collision between the vehicle and a barrier or another vehicle with low width overlap, can be reliably avoided.

This object is solved according to the invention by a motor vehicle body having the features of the independent claims. Advantageous embodiments with favorable developments of the invention are the subject matter of the dependent claims.

The motor vehicle body according to the invention for an electrically drivable motor vehicle comprises a vehicle floor element which merges into a front wall at the front end of a passenger compartment, the front wall separating the passenger compartment from a front-end structure. Respective longitudinal members, also occasionally referred to as engine mounts, extend in the region of this front-end structure and are attached at their rear ends to the front wall and to the vehicle floor element at a connection point. Furthermore, the motor vehicle body comprises a stored energy source arranged below the vehicle floor, this energy store being located with its front end below the rear ends of the longitudinal members.

In order to avoid damage to the energy store arranged below the vehicle floor element in the event of a frontal collision between the vehicle and a barrier or a vehicle with a low width overlap, for example, and the potential rotation of the corresponding longitudinal member about the vehicle transverse axis with its front end in the upwards direction or with its rear end in the downwards direction that may result from this, it is provided according to the invention that the vehicle floor element has a respective embossment formed upwardly in the vertical vehicle direction behind the respective connection point to the rear ends of the longitudinal members, and/or the respective connection point of the rear ends of the longitudinal members to the vehicle floor element has targeted weakening. Both of these measures prevent damage to the energy store when the longitudinal member rotates due to an accident about the vehicle transverse axis with its corresponding rear end in the downwards direction. The embossment of the vehicle floor element behind the corresponding connection point of the rear end of the corresponding longitudinal member to the vehicle floor element ensures that even during a corresponding rotation of the longitudinal member in the region of its rear end, the vehicle floor element cannot be pulled in the direction of the energy store and deformed in such a manner that, in the worst case scenario, it penetrates the storage housing of the energy store and damages the storage cells housed there. Instead, the respective upwardly formed embossments in the vehicle floor element mean that deformation of the vehicle floor element in this region at most leads to this vehicle floor element being deformed above the energy store, or deformation of the vehicle floor element does not cause it to penetrate sections of the energy store. The weakening provided as an alternative or in addition in the respective connection point of the rear end of the longitudinal member to the vehicle floor element also ensures that the vehicle floor element cannot be excessively pulled downwards in the direction of the energy store and deformed via this connection point, causing the damage to the energy store already described, and, instead, the targeted weakening of the connection point between the rear end of the longitudinal member and the vehicle floor element in each case ensures that this connection point will break where necessary and is specifically targeted in such a way that excessive deformation of the vehicle floor element during rotation of the longitudinal member and movement of the rear end thereof downwards in the vertical vehicle direction does not result in a corresponding deformation of the vehicle floor element in the direction of the energy store.

In an advantageous embodiment of the invention, a respective flange at the rear end of the corresponding longitudinal member is intentionally provided with recesses, reductions, or the like, for connection to the vehicle floor element. According to the invention, this should make it possible to prevent excessive dragging or deformation of the vehicle floor element downwards in the vertical vehicle direction during an accident-related rotation of the longitudinal member and a downwards movement of the rear end of the longitudinal member associated with this.

In a further embodiment of the invention, joining technology in the region of the respective connection point between the rear end of the corresponding longitudinal member and the vehicle floor element exhibits targeted weakening. For example, it is conceivable for individual weld spots to be omitted in spot welded connections, in order to achieve targeted weakening. Other joining or mechanical connection means can also be intentionally weakened, for example, by means of recesses or the like, so that overall the connection point between the rear end of the corresponding longitudinal member and the vehicle floor element is intentionally weakened or at least partially removed, thereby avoiding the dragging and deformation of the vehicle floor element referred to above, at least for the most part.

A further advantageous embodiment of the invention provides for the embossment to be arranged behind a transitional area from a main floor to a pedal floor. Experience has shown that behind this transitional area between the main floor and the pedal floor, there is a significant risk of this area being excessively deformed in the direction of the energy store when a corresponding force is applied downwards in the vertical vehicle direction in the region of the rear end of the longitudinal member. This problem is further exacerbated when the transitional area is designed as a corner area, as provided in another embodiment of the invention.

A further advantageous embodiment of the invention provides for the embossment to be arranged in the vertical vehicle direction overlapping the front end of the energy store. Particularly when the embossment is arranged directly above the energy store in the vertical vehicle direction, the protective effect of the embossment according to the invention is still further enhanced.

Furthermore, it has proved advantageous for respective connecting elements of the front wall to be connected to the outer and inner sides of the respective ends of the longitudinal members, which connecting elements are connected to the floor element. In a further embodiment of the invention, it has proved particularly advantageous for these connecting elements of the front wall to be arranged to the side of the connection point of the rear ends of the longitudinal members to the floor element. This means that the connecting elements are particularly not arranged behind the respective connection points of the rear ends of the longitudinal members to the floor element, which could lead to reinforcement of this area and therefore the risk that the connection point between the longitudinal member and the vehicle floor element is rigid enough to be dragged along in the event of an accident-related force being applied downwards in the vertical vehicle direction and deformed in such a manner that an intrusion in the storage housing of the energy store results.

Further features of the invention result from the claims, the figures, and the figure description. The features and combinations of features mentioned in the description above, as well as the features and combinations of features mentioned in the figure description below and/or shown solely in the figures, can be used not only in the combination indicated in each case, but also in other combinations or individually.

The invention will now be explained in greater detail with reference to a preferred exemplary embodiment and with reference to the drawings.

### BRIEF DESCRIPTION OF THE DRAWINGS

FIG. 1 is a partial and schematic sectional view of motor vehicle body along a sectional plane extending in the vertical vehicle and longitudinal direction in a transitional area from a main floor to a pedal floor, and from there to a front end wall which separates the passenger compartment from a front-end structure which has respective longitudinal members, each longitudinal member being arranged with its rear end at the front wall and the vehicle floor element, wherein an energy store of an electrical drive of the motor vehicle is depicted below the vehicle floor element.

FIG. 2 is a partial and schematic sectional view through the motor vehicle body according to FIG. 1 following an accident-related force being applied to the corresponding longitudinal member during a head-on collision with an obstacle or another vehicle with a low width overlap, as a result of which the longitudinal member rotates about a transverse vehicle axis and is moved downwards at a lower end in the vertical vehicle direction.

FIG. 3 is a partial perspective view of the motor vehicle body according to FIGS. 1 and 2 in the region of a respective embossment behind a connection point of the rear end of the respective longitudinal member to the vehicle floor element.

FIG. 4 is a partial bottom view of the motor vehicle body according to FIGS. 1 to 3 in the region of the connection point of the corresponding rear end of the respective longitudinal member to the vehicle floor element.

### DETAILED DESCRIPTION OF THE DRAWINGS

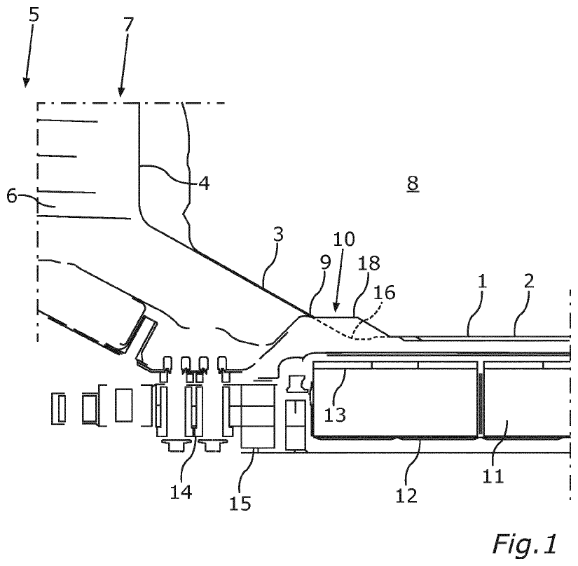

FIG. 1 shows a partial and schematic sectional view of a motor vehicle body along a sectional plane running in the vertical vehicle direction (z) and in the longitudinal vehicle direction (x) in the form of a floor panel in the transitional area from a main floor 2 to a pedal floor 3 arranged in front of it, and from there into a front wall 4 running vertically. The front wall 4 separates a passenger compartment 8 of the motor vehicle from a front-end structure 5 which comprises two longitudinal members 6, occasionally also referred to as engine mounts, which are arranged offset from one another at the height of a main longitudinal member plane and in the transverse vehicle direction, which longitudinal members extend in the longitudinal vehicle direction (x). Of the longitudinal members 6, in the present case, the left longitudinal member 6 when viewed in the forward direction can be seen. The respective longitudinal member 6 is connected at its rear end 7 to the top side in the region of the front wall 3 and to the underside in the region of the vehicle floor element 1, more accurately to the pedal floor 3. For this purpose, the respective longitudinal member 6 includes corresponding flanges, of which a flange 9 can be seen at the rear end in the present case, by means of which the rear end 7 of the longitudinal member 6 is connected to the vehicle floor element 1 in the region of a connection point 10.

Below the vehicle floor element 1, which is bounded in the present case by side sills on both outer sides of the vehicle extending in the longitudinal vehicle direction (x) and horizontally, which cannot be seen, energy store 11 is arranged, which accommodates storage cells and other electrical components of the drive in a storage housing 12. The energy store 11 in this case extends in the longitudinal vehicle direction (x) with a front portion 13 roughly as far as the transitional area between the main floor 2 and the pedal floor 3. In addition, a connecting structure 14 is visible on the front side of the energy store 11, through which a frame of the storage housing 12 is attached to the underside of the respective rear end 7 of the longitudinal member 6 or is further connected to the front axle of the motor vehicle.

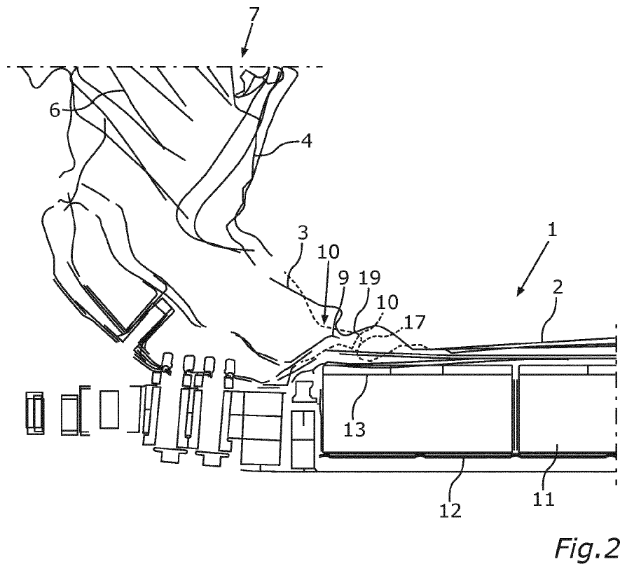

If, for example, there is a frontal collision between the motor vehicle and an obstacle, or a vehicle with low width overlap, and if, as a result of this, the laterally corresponding longitudinal member 6 is subjected to a force, with longitudinal members 6 of this kind, which have to end in the longitudinal vehicle direction (x) in front of the energy store 11, due to the arrangement of the energy store below the vehicle floor element 1, there is often a rotation about the vehicle transverse axis (y), as a result of which a front end of the longitudinal member 6 is moved or displaced upwards in the vertical vehicle direction (z) and a rear end—in the region of the connection point 10 to the vehicle floor element 1—is displaced downwards in the vertical vehicle direction (z) and possibly slightly backwards in the longitudinal vehicle direction (x). A corresponding guiding movement due to the frontal collision can be seen in this case in FIG. 2, which shows a sectional view through the motor vehicle body after a corresponding collision, similarly to FIG. 1. For example, it can be seen in this case how the rear end 7 of the corresponding longitudinal member 6 has been displaced downwards and backwards in the region of the connection point 10 to the vehicle floor 1.

In this case, a dashed line 16 in FIGS. 1 and 2 represents a transitional area of the vehicle floor element 1 between the main floor 2 and the pedal floor 3, as has hitherto been used in the prior art. In the event of an accident-related rotation of the longitudinal member 6 in the manner described in FIG. 2, due to the movement of the rear end 7 of the longitudinal member 6 in the region of the connection point 10, the transitional area of the vehicle floor element 1 is forcibly pulled downwards or deformed according to the line 17 in FIG. 2, so that there is a risk of this region 17 of the vehicle floor element 1 coming into contact with the storage housing 12 of the energy store 11, and even potentially penetrating this storage housing 12 and damaging the energy store.

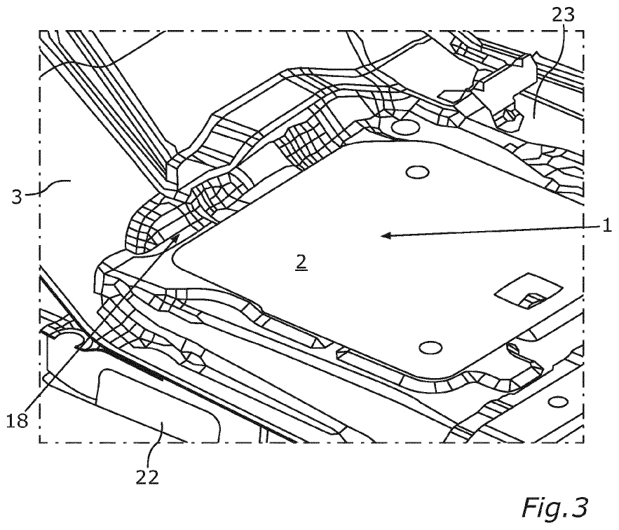

For this reason, in the present case and according to the invention, an embossment 18 is provided in the vehicle floor element 1 behind the corresponding connection point 10 with the rear end of the longitudinal member 6, so particularly in the area behind the flange 9 for connecting the rear end 7 of the longitudinal member 6 to the vehicle floor element 1. This embossment is particularly visible in FIG. 3 in a partial perspective view of the vehicle floor element 1 in the transitional area between the main floor 2 and the pedal floor 3. In particular, over the extent in the vehicle transverse direction (y), as a consequence of this, the corresponding embossment 18 is provided behind the connection point 10 or the flange 9 of the longitudinal member 6 on the vehicle floor element 1, this embossment being formed as a corresponding step, recess, or similar upward protrusion in the vertical vehicle direction (z).

If there is now a rotation of the longitudinal member 6 about the vehicle transverse axis (y), as a consequence of the accident-related application of force and moment described in connection with FIG. 2, and an accompanying downwards movement of the connection point 10 or the flange 9 of the rear end 7 of the longitudinal member 6, a corresponding deformation according to a line 19 of the transitional area indicated is likewise deformed, but it does not come into contact with the storage housing 12 of the energy store 11. Instead, there is a corresponding deformation of the embossment 18 according to the line 19 above, and at a distance from, the front end 13 of the energy store 11.

Apart from this embossment 18, it is provided in addition or alternatively that the corresponding connection point 10 of the rear end 7 of the longitudinal member 6 to the vehicle floor element 1 has targeted weakening. For example, it is contemplated in this case that the flange 9 extending in the vehicle transverse direction (y) for fastening the rear end of the longitudinal member 6 to the vehicle floor element 1 is either intentionally shortened, provided with recesses, or weakened in a similar manner. Additionally, a joining technology between the flange 9 and the vehicle floor element 1, so in the region of the connection point 10, can be intentionally weakened, in order to avoid excessive dragging and deformation of the vehicle floor element 1 during an accident-related rotation of the longitudinal member 6 and a corresponding downwards movement of the connection point 10 or the flange 9 of the longitudinal member 6. For example, targeted spot welds can be omitted in this case or joint connections can be designed to be weaker, so that in the event of a downwards movement of the flange 9 or the connection point 10, as described, it breaks, for example, thereby preventing excessive downwards deformation of the vehicle floor element 1 in the vertical vehicle direction. Ideally, both measures, the targeted embossment 18 of the vehicle floor element 1 and the targeted weakening of the connection point 1 between the rear end 7 of the longitudinal member 6 and the vehicle floor element 1, are used together. However, it should be specifically mentioned that each of these measures also works separately.

In the present case, the effect is further enhanced by the embossment 18 being provided in a transitional area between the main floor 2 and the pedal floor 3 designed as a corner area.

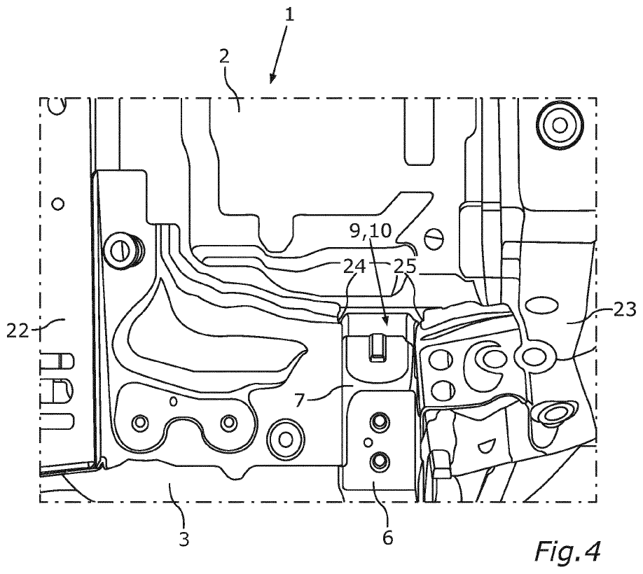

It can also be seen from FIG. 4, which shows a partial bottom view of the motor vehicle body in the region of the rear end 7 of one of the two longitudinal members 6, that an outer connecting element 20 and an inner connecting element 21 are provided on the outside and inside, respectively, of the respective rear end 7 of the longitudinal member 6, wherein the outer connecting element 20 extends substantially between the longitudinal member 6 and a side sill 22, and the inner connecting element 21 between the longitudinal member 6 and a center tunnel 23. In particular, it can be seen here that the connecting elements 20, 21, which connect the vehicle floor element 1 on the outside to the front wall 4, are arranged to the side of the respective connection point 10 of the corresponding rear end 7 of the longitudinal member 6 to the vehicle floor element 1. This means, on the other hand, that the two connecting elements 20, 21 are not arranged directly in the region of the connection point 10 or the flange 9, but rather end in the region of the respective edges 24, 25 to the side thereof. This also contributes to a targeted weakening in the region of the connection point 10 or in the region of the flange 9, in the event of a corresponding accident-related downwards movement of the rear end 7 of the longitudinal member 6.

### LIST OF REFERENCE NUMBERS

1 Vehicle floor element
2 Main floor
3 Pedal floor
4 Front wall
5 Front-end structure
6 Longitudinal member
7 End
8 Passenger compartment
9 Flange
10 Connection point
11 Energy store
12 Storage housing
13 End
14 Connection structure
16 Line
17 Line
18 Embossment
19 Line
20 Connecting element
21 Connecting element
22 Side sill
23 Center tunnel
24 Edge
25 Edge

1.-8. (canceled)

9. A motor vehicle body for an electrically drivable motor vehicle, comprising:
a front wall at a front end of a passenger compartment;
a vehicle floor which merges into the front wall at the front end of the passenger compartment;
respective longitudinal members of a front-end structure which are attached at rear ends thereof to the front wall and to the vehicle floor at respective connection points; and
an energy store arranged below the vehicle floor, said energy store being arranged with a front end below the rear ends of the longitudinal members, wherein
the vehicle floor has a respective embossment formed upwardly in a vertical vehicle direction behind the respective connection points to the rear ends of the longitudinal members, and/or
the respective connection points of the rear ends of the longitudinal members to the vehicle floor have a targeted weakened portion.

10. The motor vehicle body according to claim 9, wherein
a respective flange at the rear end of a corresponding longitudinal member has targeted recesses or reductions for connection to the vehicle floor.

11. The motor vehicle body according to claim 10, wherein
a joint in a region of the respective connection point between the rear end of the corresponding longitudinal member and the vehicle floor exhibits targeted weakening.

12. The motor vehicle body according to claim 9, wherein
the embossment is arranged behind a transitional area of a main floor and a pedal floor.

13. The motor vehicle body according to claim 12, wherein
the transitional area is configured as a corner area.

14. The motor vehicle body according to claim 12, wherein
the embossment is arranged in the vertical vehicle direction overlapping the front end of the energy store.

15. The motor vehicle body according to claim 9, wherein
respective connecting elements are connected to outer and inner sides of the rear ends of the longitudinal members, via which connecting elements the front wall is connected to the vehicle floor.

16. The motor vehicle body according to claim 15, wherein
the connecting elements of the front wall are arranged to a side of the connection point of the rear ends of the longitudinal members to the vehicle floor.
